(19) United States
(12) Patent Application Publication
(10) Pub. No.: US 2021/0387158 A1
(43) Pub. Date: Dec. 16, 2021

(54) CARBON BLACK CONVERSION INTO MICROPOROUS CARBON

(71) Applicants: Swansea University, Swansea (GB); Swansea University, Swansea (GB); Swansea University, Swansea (GB); Swansea University, Swansea (GB)

(72) Inventors: SAEID KHODABAKHSHI, Swansea (GB); ENRICO ANDREOLI, Swansea (GB); SAJAD KIANI, Swansea (GB); ANDREW ROSS BARRON, Swansea (GB)

(73) Assignee: Swansea University, Swansea (GB)

(21) Appl. No.: 16/940,445

(22) Filed: Jul. 28, 2020

Related U.S. Application Data
(60) Provisional application No. 63/038,138, filed on Jun. 12, 2020.

(51) Int. Cl. B01J 20/20; C01B 32/318; C01B 32/342; B01J 20/28; B01J 20/30

(52) U.S. Cl. CPC B01J 20/20; C01B 32/318; C01B 32/342; B01J 20/28061; B01J 20/28071; B01J 20/2808; C01P 2002/82; B01J 20/3078; C01P 2006/12; C01P 2006/14; C01P 2006/16; C01P 2004/03; C01P 2004/04; B01J 20/3085

(57) ABSTRACT

The present invention is related to highly oxygenated nanoribbons and highly microporous carbon (mPC) produced by the oxidation of a series of carbon blacks in nitric acid followed by fast and slow pyrolysis, respectively. New porous carbons according to the invention does not need to be activated by strong alkaline activators, for example, KOH and NaOH. The best prepared mPC showed a high capacity for carbon dioxide capture of 1 to 3.9 mmol/g at pressures between 0.15 and 1 bar and 25° C.

### CROSS-REFERENCE TO RELATED APPLICATIONS

This application claims benefit of U.S. provisional patent application Ser. No. 63/038,138, filed Jun. 12, 2020, which is herein incorporated by reference in its entirety.

### BACKGROUND

### Field

Embodiments of the present disclosure generally relate to a process for the conversion of carbon black into highly microporous carbon without the need for strong alkaline activators.

### Description of the Related Art

For the time being, fossil fuels remain dominant source of supply for global energy demand and CO₂ emission as a consequence of burning fossil fuels remain the major global problem (Brockway et al., 2019). Among CO₂ mitigation strategies, CO₂ capture and storage (CCS) has become increasingly popular over the past decades as it can effectively remove CO₂ from the source point of emission to great extent. From 1930 to the present, the most used technology to remove CO₂ has been based on sorption and stripping with aqueous amines as a feasible method which suffers from a series of inherent problems including the corrosive nature of the liquid phase amine-based absorption, unpleasant poisonous smell, fouling of the process equipment, decomposition at high temperature, and high regeneration energy (Dutcher et al., 2015). To overcome these critical problems solid sorbents such as porous carbons (PCs) (Zhang, et al, 2019), metal-organic frameworks (MOFs) (Ding et al., 2019), and zeolite (Murge et al., 2019) etc. have emerged as promising capture materials because they usually require lower capital cost, lower pressure for gas recovery, and less regenerated energy (Wang et al., 2014). In spite of having general advantages over liquid amines, the solid capture materials also have some drawbacks. For example, most of the MOFs and zeolites are unstable in moisture or at high-temperature, expensive, or require sacrificial templates (Hu et al., 2019) Therefore, inexpensive and widely available materials are needed, which include PCs. In this way, carbon black (CB) and porous carbon (PC) appear as excellent alternatives because these materials are widely used in industry or generated as combustion by products. The use of PCs as gas adsorbent has grown over the past years because of their inherent strength, low preparation cost, high stability against humidity and high operating temperature, easy regeneration, and sustainability (Zhang et al., 2019).

Most current methods for production of activated carbon (AC) or porous carbon (PC) is through activation of a carbon precursor by treatment with a base, such as potassium hydroxide (KOH), sodium hydroxide (NaOH) or lithium hydroxide (LiOH) (Ghosh, et al., U.S. Pat. No. 10,232,342). Unfortunately, these hydroxides and their solutions are severe irritants to skin and other tissue. Furthermore, the vapor formed during activation is corrosive and etch typical reaction chambers such as glass. The resulting PC needs additional purification step using acids which makes the process harsh and tedious, and they are also corrosive which is a hindering its use in terms of industrial production of amorphous carbon (AC). This makes scale-up problematical and impractical. Other activation processes involve the use of strong acids.

In addition, activated carbons are usually produced by pyrolysis with a low heating rate of 1-10° C./min which make the process long and energy intensive.

There are a few methods for CB conversion into PC, including method for producing activated carbon from carbon black using waste tires (Teng & Wang, U.S. Pat. No. 6,337,302) and production of molded activated carbon from carbon black and petroleum pitch by alkaline activation (Kugatov et al, 2016).

The fabrication of AC for CO₂ capture has been accomplished in a variety of different ways mostly using alkali activating agents and various precursors such as polysaccharide (Li et al., 2017), heterocyclic aromatic organic compounds (El-Kaderi et al., US Application 2019/0119120), a hyper-cross-linked porous aromatic polymer (Marchese, et al., EP3328537A1), lignocellulose (Baker, U.S. Pat. No. 5,710,092), or a carbon precursor solution prepared by reacting phenol with formaldehyde (Meisner et al., US Application 2011/0177940).

The incorporation of mesopores into microporous carbon (preferably activated coconut carbon) has been demonstrated using and alkaline earth metal salt or an alkali metal salt such as calcium nitrate (Branton et al., US Application 2012/0174936A1). As an alternative method involves modification of the microporous structure of a carbon material by a post-carbonization process (Putyera et al., U.S. Pat. No. 6,225,257).

It is desirable to have a synthesis of highly porous carbon materials that does not require activation with strong bases. The present invention provides the method for reaching this goal.

### SUMMARY

In one embodiment, a new alkali-free approach to the conversion of commercial carbon black (CB) into carbon nanoribbons and different grades of heteroatom-doped microporous carbons with high CO₂ capture performance is provided. Considering the high tendency of industries to clean and cost-effective production, the most adventitious feature is the use of an alkali metal-free process where porous carbons (PCs) with different textural properties are synthesized from different grade of carbon black (CB), namely commercial carbon soot (CS).

In another embodiment, all synthesized PCs were evaluated for CO₂ capture and showed high performance particularly at low pressure because of abundance of ultramicropores. Most of materials for CO₂ capture also suffer from some disadvantages, including low CO₂ sorption capacity and selectivity at low pressure and room temperature, high regeneration cost, corrosiveness, and instability.

In yet another embodiment, a method of preparing oxygenated nanoribbons and various mPC with different morphology from CB containing different level of oxygen is provided. In a variation of the present invention, a wide range of CB grades are employed. The method for oxygenated nanoribbons and microporous nanocubes applies to CB grade Pearl 2000 and the method for mPC production in general applies to all CB grades (acetylene black, channel black, furnace black, lamp black and thermal black). Using nitric acid for CB oxidation offers a desired level of oxygen content by controlling the reaction time. Both high and low heating rate for pyrolysis process are applied and there is no appreciable difference in final product making fast pyrolysis more reasonable in terms of energy saving.

Different type of commercial soots or carbon blacks (CBs) have been used as a precursor for synthesis of new types of nanomaterials with different morphology and porosity. Among all CB used, Pearl 2000 as one of the most porous CB in the market proved to be an interesting precursor to produce new homogenous graphitic-like ribbons with high oxygen content of ˜50 w % and diameter of 20 nm while other CB grades lead to different randomly shaped nanoparticles and carbon quantum dots. The representative nanomaterials then were used to produce microporous carbons by slow and fast carbonization in a self-templated method without using activating agent yielding unshaped particles and highly ordered nanocubes (˜250 nm), respectively. Although the best microporous carbons synthesized have lower surface area and pore volume than pristine CB model, they showed more capacity for the CO₂ uptake at low and atmospheric pressures and ambient temperature. Although porous carbon can be obtained from biomass but always needs KOH/HCL which makes the process costly and hazardous and we should burn a green source. It can be also produced from chemicals which need complicated chemistry and comes with much price and low yield as the result of burn-off. On the other hand, herein, we present an efficient approach for alkali activation-free conversion of almost all CB grades to different O/N-doped mPCs with high CO₂ capture performance at room temperature and atmospheric pressure while most pristine CBs even with high surface area fail to respond.

In some embodiments, the mPCs of the present invention include a porous carbon material with a carbon content of between 75% and 92% as measured by elemental analysis. In some embodiments, the porous materials of the present disclosure include a porous carbon material with a surface area of 250-850 m²/g, a total pore volume of at least 1.35 cm³/g, and a carbon content of between 80% and 95% as measured by X-ray photoelectron spectroscopy.

In a further embodiment, the oxidized carbon black (OCB) of the present disclosure are prepared in different times and four fractions are separated by centrifugation. In some embodiments, the temperature of pyrolysis is between 700° C. and 900° C. Oxygen functionalities can be introduced during the acid treatment step and oxygen content can be manipulated by time control.

### BRIEF DESCRIPTION OF THE DRAWINGS

So that the manner in which the above recited features of the present disclosure can be understood in detail, a more particular description of the disclosure, briefly summarized above, may be had reference to embodiments, some of which are illustrated in the appended drawings. It is also noted, however, that the appended drawings illustrate only exemplary embodiments. And are therefore not to be considered limiting in scope, may be admit to other equally effective embodiments.

FIG. 1 illustrates a schematic of the synthesis of mPC from soot models.

FIG. 2 illustrates a synthesis of mPCs from carbon black grade Pearl 2000.

FIG. 3 is scanning electron microscope images for porous carbons synthesized from CB produced according to an embodiment described herein.

FIG. 4 is scanning electron microscope images for oxidized Pearl 2000 and porous carbons synthesized from Pearl 2000 produced according to an embodiment described herein.

FIG. 5 is transmission electron microscope images for NRs obtained from pearl 2000 (a), PC-C (b) and PC-C′ (c) and scanning transmission electron microscope images of NRs (d), PC-C (e), PC-C′ (f), and scanning electron microscope images for NRs (g), PC-C (h), PC-C′ (i), produced according to an embodiment described herein.

FIG. 6 is transmission electron microscope and scanning transmission electron microscope images for OCB (supernatant of centrifugation) obtained from evaporation of nitric acid, Vulcan R-72 (a, b), Vulcan 3 (c, d), and Monarch 1000 (e, f), produced according to an embodiment described herein.

FIG. 7 is transmission electron microscope and scanning transmission electron microscope images for NRS obtained from Pearl 2000. TEM shows graphitic layers distance of 0.3 nm, produced according to an embodiment described herein.

FIG. 8 is scanning transmission electron microscope (a) and transmission electron microscope (b) images for PC-P, produced according to an embodiment described herein. High-angle annular dark-field scanning transmission electron microscope and elemental mapping images of PC-P shows the presence of oxygen and small amount of nitrogen in porous carbon.

FIG. 9 is scanning transmission electron microscope and transmission electron microscope images at different magnifications for PC-C′. SAED revealed an amorphous nature for cube-like particles, produced according to an embodiment described herein.

FIG. 10 is Fourier transfer infrared spectra of pristine CB-P, OCB, NRs, and PC-C, produced according to an embodiment described herein.

FIG. 11 is Raman spectra of pristine CB-P, PC-C, and PC-C′, produced according to an embodiment described herein.

FIG. 12 is a plot of pore size distribution calculated by NL-DFT for synthesized mPCs, produced according to an embodiment described herein.

FIG. 13 is plots of CO₂ and N₂ uptakes for the synthesized mPCs, produced according to an embodiment described herein, at 25° C. and different pressures.

FIG. 14 is a plot of the recyclability of PC-C, produced according to an embodiment described herein, over 8 runs at 45° C.

Various components of the same type may be distinguished by following the reference label by a letter that distinguishes among the similar components and/or features.

### DETAILED DESCRIPTION

The present disclosure relates to the application of wet oxidation of CB to make oxidized carbon black (OCB) as precursor for production of our new porous carbon materials (PCs). The aim supporting the use of this strategy to make CB-containing oxygen group is to take advantage of its unique ability in self-activation rather than using auxiliary activating agent during pyrolysis. In fact, we supposed that oxygen functionalities can play a similar role to that of auxiliary activating agents like alkali metals, but they can eliminate the cumbersome and hazardous purification steps after carbonization.

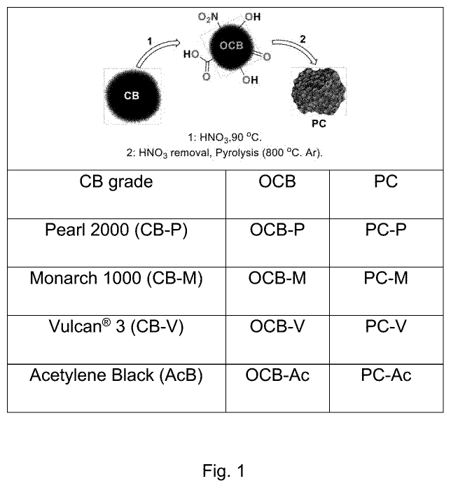

FIG. 1 illustrates the pathways to synthesis different types of PSs with abundant ultramicropores. In a general procedure for CB oxidation reported in literature, the OCB is separated from the reaction mixture by centrifugation as sediment and the supernatant is usually discarded, while we only removed HNO₃ upon reaction completion without centrifugation and used the residue (OCB) without any further purification as precursor. The obtained PCs were initially characterized by elemental and surface analysis. However, to find the most suitable sorbent for CO₂ capture, all synthesized PCs were examined by TGA method where PC-P (porous carbon obtained from Pearl 2000) was found to be the outperformer by a CO₂ uptake of 3.7 mmol/g at room temperature and atmospheric pressure.

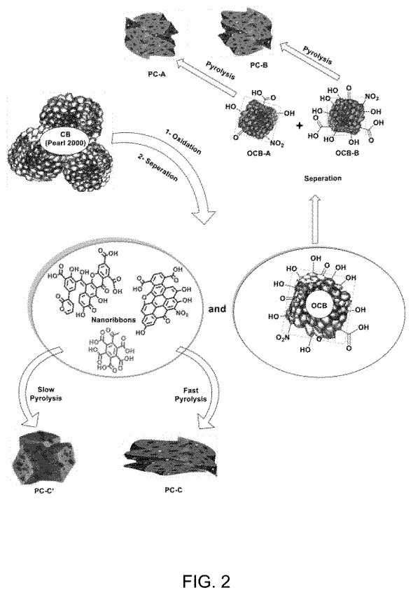

Followed by more examining and in order to maximize the performance of PC-P, in another variation, we also set a series of experiments where three different fractions could have been separated from OCB-P for subsequent pyrolysis. FIG. 2 demonstrates a comprehensive map of fractions extraction as precursor to produce a series of mPCs with different textural properties.

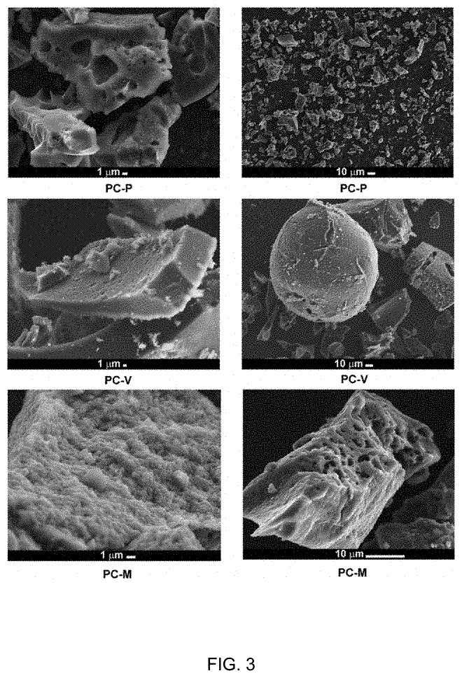

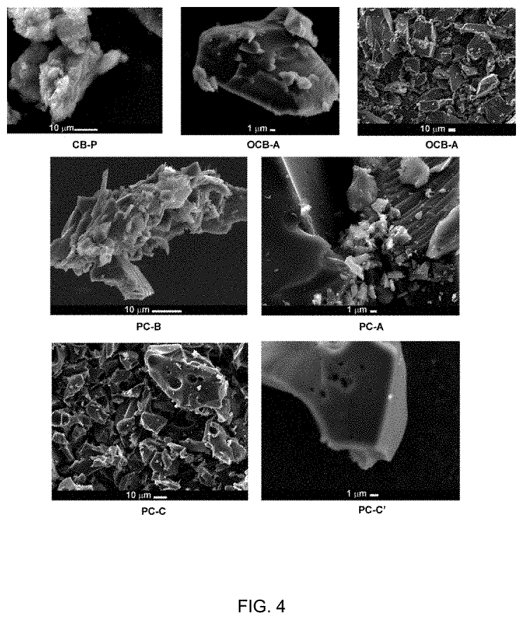

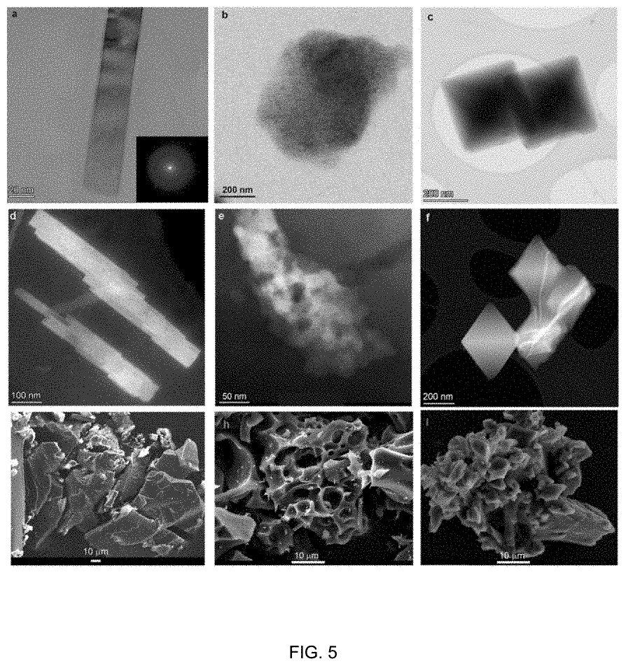

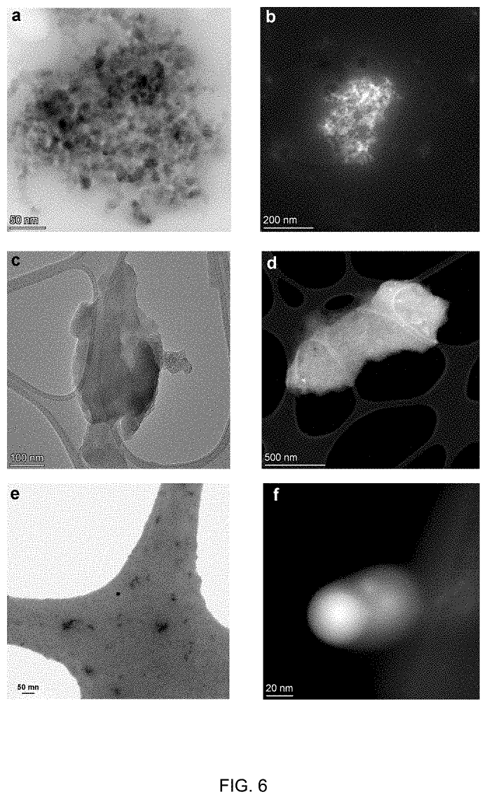

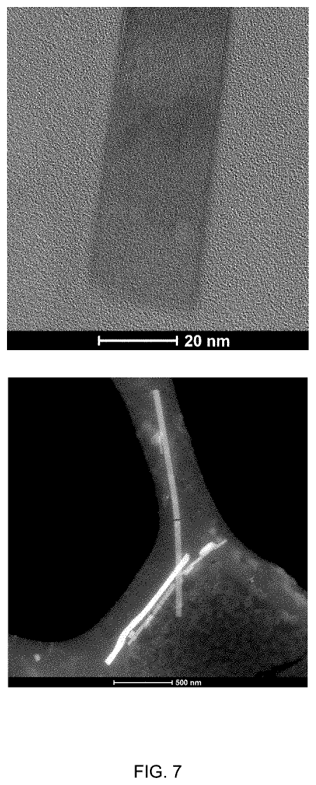

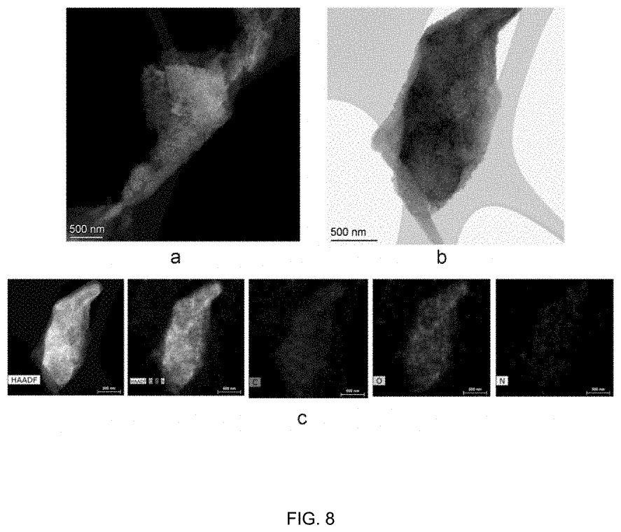

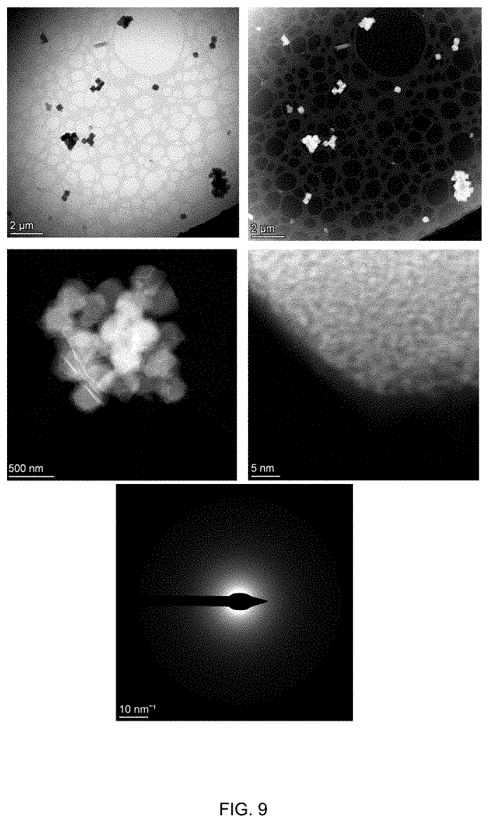

Scanning electron microscopy (SEM) images of all oxidized carbon blacks (OCBs) and their pyrolyzed products are collected in FIG. 3 and FIG. 4 showing the morphological change trend form CB to mPC in all test grades. Selecting Pearl 2000 as a model and scrutinizing its products structure by TEM and STEM revealed interesting particle morphologies as can be seen in FIG. 5. In some recently published paper, graphene quantum dots (GQDs) have been obtained from nitric acid treatment of CB, Vulcan XC 72R), through small fragments separation by centrifuge (Dong et al., 2012). Here we observed that not all grades of CB can be used to produce GQDs and compounds having distinctive morphology can be extracted from each CB grade after oxidation. It should be noted that the above-mentioned GQDs are separated from HNO₃ after CB oxidation as smaller fragments by centrifugation. In line with the main aim of this study and as a preliminary investigation, we expanded this method for other grades of CB such as Pearl 2000, Vulcan®3, Monarch 1000, and Acetylene black to obtain GQDs or carbon quantum dots (CQDs). In case of acetylene black (AcB), however, a very poor yield of small fragments has been experienced which is likely because of low degradability of AcB against oxidation which is discussed later. Except CB (Vulcan XC 72R), neither GQDs nor CQDs were obtained from the test CBs. STEM and TEM for all samples obtained from Vulcan XC 72R, Pearl 2000, Vulcan® 3, and Monarch 1000 can be seen in FIG. 6 and FIG. 7. Interestingly, TEM and STEM revealed that the smaller fragments of CB (Pearl 2000) after HNO₃ oxidation, mainly consist of highly oxygenated graphitic nanoribones (NRs) (FIGS. 5a and d) surrounded by functional group. The inset in FIG. 5a indicates the crystallinity of NRs by selected area electron diffraction (SAED). SEM image of the NRs, however, shows a typical agglomeration of particles (FIG. 5g). Surprisingly, it was disclosed that the heating rate can affect the morphology of pyrolyzed NRs, markedly. By a fast pyrolysis, however, NRs led to unshaped aggregated particles (FIG. 5b, e, and h), while slow pyrolysis could yield distinctive cubic particles (FIG. 5c, f, i). FIG. 5 represents a morphological trend which ribbons with an average diameter of 20 nm are converted into mPCs with randomly shaped (FIG. 5b, e, and h) morphology denoted as PC-C and cubic shaped (FIG. 5c, f, and i) morphology denoted as PC-C′ over thermal treatment. More TEM, STEM, and SEM images at different magnification have been provided in FIG. 8 and FIG. 9.

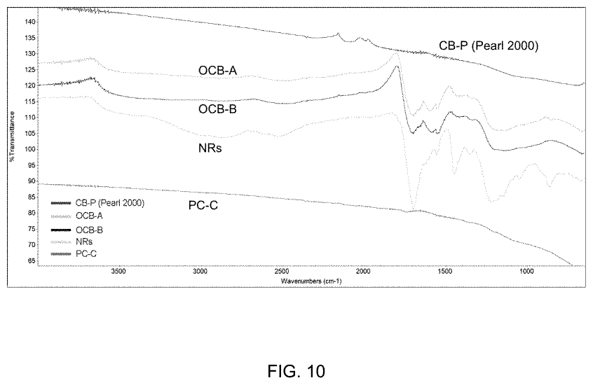

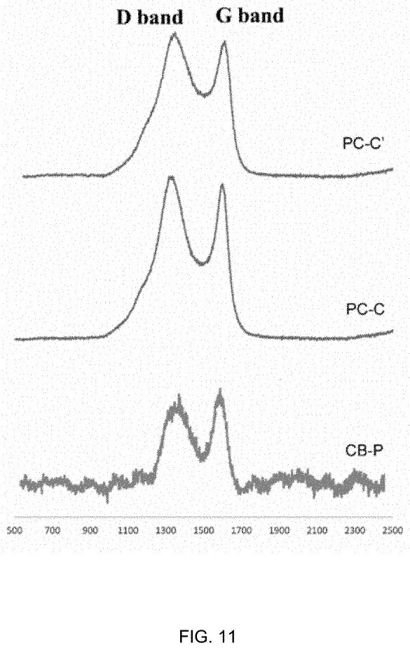

As representative, FIG. 10 shows the FT-IR spectra of pristine CB-P, OCB&NRs, and PC-C. Indeed, the IR pattern for CB is dramatically changed over oxidation process by appearing characteristic peaks such as OH and C═O. However, similar to other activated carbons, no significant peak was detected in the PC-C since most functional groups are broken away during carbonization. FIG. 11 also shows the Raman spectra for CB-P, NRs, and PC-C, while a slight change is seen in the ratio of D band representing SP³ carbon content and G band representing SP² carbon. The XRD for the representative final products (PC-C and PC-C′) have also showed an amorphous nature for the porous carbons.

The elemental analyses of the pristine CB-P, oxidized, and pyrolyzed products are summarized in Table 1. It is clear that the level of oxygen content increases remarkably after oxidation. CB-P was found to be fully oxidized in 5 days giving OCBs and NRs with oxygen content up to roughly 52 w %. However, some nitrogen can be also detected as a result of reaction of CB active sites with NOx. After carbonization, most of the oxygen functionalities were removed from carbon framework while most of nitrogen remains within the structure. This is worth mentioning that heating rate also can influence the mechanism of carbonization as PC-C contain much more oxygen content than PC-C′ meaning less oxygen is released during fast pyrolysis.

TABLE 1

| | Elemental analysis (w %) | | | |
|---|---|---|---|---|
| Sample | C | H | N | O |
| CB-P | 97.19 | 0.77 | 0 | 2.04 |
| OCB-P | 48.34 | 2.38 | 1.72 | 47.58 |
| OCB-A | 55.24 | 2.548 | 0.92 | 41.29 |
| OCB-B | 52.59 | 2.158 | 0.99 | 44.26 |
| NRs | 46.39 | 2.435 | 1.05 | 50.12 |
| PC-P | 80.39 | 1.87 | 2.8 | 14.94 |
| PC-A | 91.74 | 0.23 | 1.68 | 6.35 |
| PC-B | 88.90 | 1.74 | 1.50 | 7.86 |
| PC-C | 77.33 | 1.91 | 2.18 | 22.7 |
| PC-C′ | 84.29 | 1.50 | 2.35 | 11.86 |

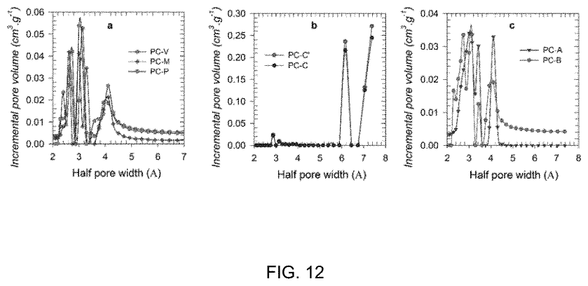

The textural properties of the spheres such as surface area and pore volume, and pore size distribution for all samples (Except PC-Ac) were measured and the textural parameters obtained from the N₂ (77 K) and CO₂ (273 K) adsorption data are shown in Table 2. BET surface areas were estimated using N₂ at 77 K, while pore size distributions were calculated using non-localized density functional theory (NL-DFT) with data collected with CO₂ at 273 K. In accordance with the IUPAC classification, all samples showed type I isotherms, suggesting microporous structures (Robens, 1999) FIG. 12 presents the pore distributions for best PCs, in the range below 1.4 nm (pore diameter=2 times the half pore width) confirming the high abundance of micropores which are favorable for CO₂ molecules capture at low pressures.

TABLE 2

| | | Total pore | |
|---|---|---|---|
| | S _{BET} | volume | Half pore |
| | (m² · | V_{Total} | width |
| Sample | g⁻¹) | (cm³ · g⁻¹) | (DFT) (Å) |
| PC-M | 598.312 | 0.151 | 2.619 |
| PC-P | 773.53 | 0.190 | 2.998 |
| PC-V | 637.9 | 0.208 | 3.2 |
| PC-A | 320 | 0.117 | 2.998 |
| PC-B | 475 | 0.151 | 3.136 |
| PC-C | 811.129 | 0.200 | 7.374 |
| PC-C′ | 933.976 | 0.233 | 7.374 |

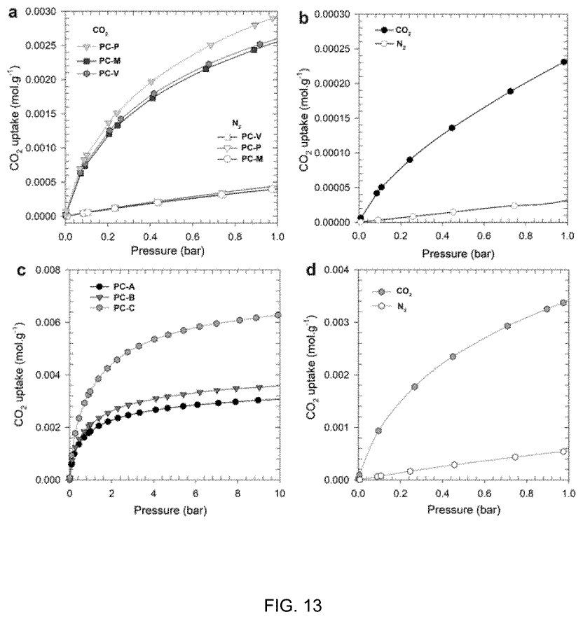

The CO₂ uptake performance of the first group of synthesized microporous carbons (FIG. 1) were measured by studying the CO₂ physisorption isotherms at 25° C. from 0.1 to 10. Also, The CO₂ adsorption isotherms for each sample showed by elevating the pressure from 0.1 bar, no saturated state is observed suggesting a greater CO₂ uptake capacity at higher pressures. FIG. 13a presents a comparison for CO₂ uptake and selectivity over N₂ of the first group of synthesized mPCs. The following order was determined for uptake performance: PC-P (2.85 mmol/g)>PC-V (2.60 mmol/g)>PC-M (2.55 mmol/g). FIG. 13b also shows the performance of PC-Ac with a very poor uptake of 0.02 mmol/g. Undeniably, PC obtained from Pearl 2000 (PC-P) and PC obtained from Acetylene Black (PC-Ac) exhibited highest and lowest capacity, respectively. The reason being for the low performance of PC-Ac is that the pristine AcB has larger and less fragmented basal structural unit (BSU) than other CB grades which results in fewer accessible edge sites and less activation towards oxidation. Therefore, the lower oxygen content in OCB leads to less porosity during pyrolysis which has a significant effect on CO₂ uptake.

From carbon capture, utilization and storage (CCUS) economical point of view, one of the major criteria in adsorption-based CO₂ capture unit is high selectivity of CO₂ over N₂. Considering that a typical flue gas stream emitted from coal-fired power plants contains about 15% of CO₂, 75% of N₂, and 10% of other volatile components, we applied CO₂ and N₂ estimated partial pressures (0.15 and 0.85 bar, respectively) to calculate the selectivity. Accordingly, the adsorption selectivity of CO₂ over N₂ for all samples at 25° C. are also seen in FIG. 13a and determined as PC-V (17.7), PC-P (17.3), and PC-M (16.5) which PC-P which are in the same range of recently reported porous carbons.

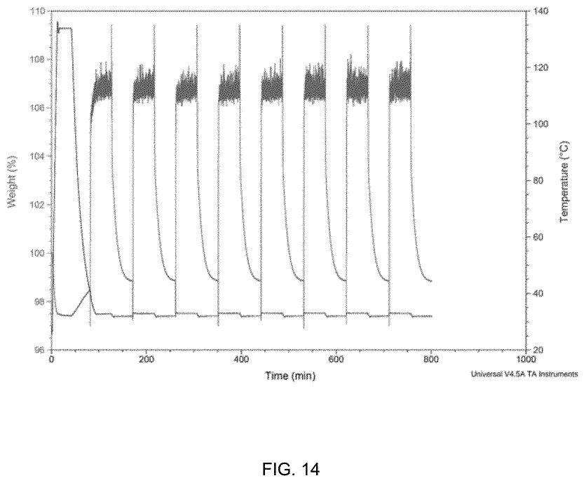

High performance of PC-P encouraged us to expand the scope of synthesis and scrutinize the potential of Pearl 2000 as a model precursor for production of more PCs. As mentioned earlier, CB-P could be efficiently converted into three different OCB fractions as OCB-A, OCB-B, and highly oxygenated NRs. After thermal treatment under inert gas, each fraction led to microporous carbons with different surface area, pore volume, and oxygen content. FIG. 13c depicts uptake efficiency of each fractions where PC-C obtained from fast pyrolysis of NRs show the highest CO₂ capture capacity at 25° C. and 1 bar. The CO₂ uptake performance of PC-A was the lowest, even though it had the higher volume of narrow pores compared to PC-B. In all other cases a relatively good linear correlation between the micropore volume, surface area and the amount of CO₂ adsorbed was found. The selectivity of CO₂ over N₂ for PC-C is determined as 15 and can be seen from FIG. 13d. FIG. 14 shows the recyclability of a representative sample PC-C over 8 run with no obvious change in uptake performance.

### Examples

Scanning tunneling electron microscopy (STEM) and high-resolution transmission electron microscopy (HRTEM) images of the spheres were performed using a JEOL 2100F Transmission Electron Microscope. Energy dispersive X-ray spectroscopy (EDS) was conducted on a carbon grid. Scanning electron microscopy (SEM) images of the spheres were obtained with a JEOL 7800F FEG SEM (JEOL, Akishima, Tokyo, Japan). The Raman data of the carbon spheres were recorded at room temperature using a Renishaw inVia Raman Microscope (Renishaw plc, Miskin, Pontyclun, UK) with excitation wavelength of 457, 514, and 633 nm. The elemental analyzer (vario EL cubewas, Germany) was used to determine the amount of carbon, hydrogen and oxygen. The samples were characterized using a Thermo Scientific Nicolet iS10 FT-IR Spectrometer. Thermogravimetric analysis (TGA) was carried out using 10-mg samples with a TA Instruments SDT Q600 at a heating rate of 5° C.·min⁻¹ from room temperature to 900° C. in air. N₂ adsorption/desorption isotherms were obtained using a Quadrosorb SI (Quantachrome Instruments, Boynton Beach, Fla., USA). Specific surface areas were calculated based on the Brunauer-Emmett-Teller (BET) method, and pore size distribution was determined using the non-localized density functional theory (NL-DFT) method. X-ray photoelectron spectroscopy (XPS) was performed using a Kratos Axis Supra (Kratos Analytical, Japan) utilizing a monochromatic Al-K_{α} X-ray source (K_{α} 1486.58 eV), 15 mA emission current, magnetic hybrid lens, and slot aperture. Region scans were performed using a pass energy of 40 eV and step size of 0.1 eV. Peak fitting of the narrow region spectra was performed using a Shirley type background, and the synthetic peaks were of a mixed Gaussian-Lorentzian type. Carbon sp² was used for charge reference assumed to have a binding energy of 284 eV. The thermal synthesis reactions were carried out in a two-zone furnace (SSP-354 Reactor, Nanotech Innovations, 132 Artino St., Oberlin, Ohio, USA). All the adsorbents were degassed at 160° C. under vacuum for 2 h prior to adsorption study. CO₂ adsorption performance of carbon spheres were measured volumetrically in an Isorb apparatus (Germany) at four different temperatures (0, 25, 35 and 45° C.) and pressures from 0.1 to 10 bar. Degasification temperature was internally controlled by covering the cell, containing the sample, with a thermojacket, while the adsorption temperature was adjusted by a jacketed beaker connected to a circulating bath containing water and ethylene glycol. For each experiment, about 200 mg of carbon spheres was used for the adsorption studies. Ultra-pure CO₂ (99.9%) and N₂ (99.9%) as gas sources were used throughout the experiments. N₂ adsorption experiments at 25° C. and different pressures were also recorded through the same procedure for CO₂. NOVA 2000e volumetric adsorption analyzer (Quantochrome) was carried out to assess the surface area, pore volume, and pore size distribution using N₂ (−196° C., 99.9% purity) and CO₂ (0° C.). For each adsorption-desorption analysis, the cell was filled with a specific amount of sample, it was then weighted and loaded into the degas port. After this, the heating pockets were attached, and then degassed under a vacuum pump for 8 h at 150° C. Once degassing time was completed, each carbon sphere sample was backfilled with helium to avoid the sample being dosed with CO₂ before analysis. It is noted that, carbon-based materials are mostly non-microporous and highly sensitive. The specific surface area (SBET) measurement was taken from N₂ adsorption and analyzed using the Brunauer-Emmett-Teller (BET) model within relative pressure (p/p₀) of 0.05-0.99. Incremental pore size distribution and pore volume were taken from CO₂ measurements and calculated using the DFT method.

Example 1. 5 g of CB (acetylene black) was placed in a round bottom flask containing 100 mL nitric acid (HNO₃) and stirred at 90° C. for 120 h. Then, the nitric acid was removed by evaporation under vacuumed yielding oxidized carbon black (OCB) as dark brown powder. Obtained OCB were used for the next step without any further process and purification.

Example 2. 5 g of CB (Pearl 2000) was placed in a round bottom flask containing 100 mL nitric acid (HNO₃) and stirred at 90° C. for 48 h. Then, the nitric acid was removed by evaporation under vacuumed yielding oxidized carbon black (OCB) as dark brown powder. Obtained OCB were used for the next step without any further process and purification.

Example 3. 5 g of CB (Pearl 2000) was placed in a round bottom flask containing 100 mL nitric acid (HNO₃) and stirred at 90° C. for 120 h. Then, the nitric acid was removed by evaporation under vacuumed yielding oxidized carbon black (OCB) as dark brown powder. Obtained OCB were used for the next step without any further process and purification.

Example 4. 5 g of CB (Monarch 1000) was placed in a round bottom flask containing 100 mL nitric acid (HNO₃) and stirred at 90° C. for 120 h. Then, the nitric acid was removed by evaporation under vacuumed yielding oxidized carbon black (OCB) as dark brown powder. Obtained OCB were used for the next step without any further process and purification.

Example 5. 5 g of CB (Vulcan R-X72) was placed in a round bottom flask containing 100 mL nitric acid (HNO₃) and stirred at 90° C. for 120 h. Then, the nitric acid was removed by evaporation under vacuumed yielding oxidized carbon black (OCB) as dark brown powder. Obtained OCB were used for the next step without any further process and purification.

Example 6. 5 g of CB (Vulcan 3) was placed in a round bottom flask containing 100 mL nitric acid (HNO₃) and stirred at 90° C. for 120 h. Then, the nitric acid was removed by evaporation under vacuumed yielding oxidized carbon black (OCB) as dark brown powder. Obtained OCB were used for the next step without any further process and purification.

Example 7. 1 g of OCB (obtained from Example 1) was placed in a ceramic boat in a horizontal cylindrical furnace with an inner diameter of 35 mm and then heated at a rate of 60° C. min⁻¹ up to 800° C. under argon. Heating was kept for 1 h, then, the furnace was cooled down to room temperature under argon. The resulting black powder was collected from the boat and used directly for CO₂ uptake experiment without any purification.

Example 8. 1 g of OCB (obtained from Example 2) was placed in a ceramic boat in a horizontal cylindrical furnace with an inner diameter of 35 mm and then heated at a rate of 60° C. min⁻¹ up to 800° C. under argon. Heating was kept for 1 h, then, the furnace was cooled down to room temperature under argon. The resulting black powder was collected from the boat and used directly for CO₂ uptake experiment without any purification.

Example 9. 1 g of OCB (obtained from Example 3) was placed in a ceramic boat in a horizontal cylindrical furnace with an inner diameter of 35 mm and then heated at a rate of 60° C. min⁻¹ up to 800° C. under argon. Heating was kept for 1 h, then, the furnace was cooled down to room temperature under argon. The resulting black powder was collected from the boat and used directly for CO₂ uptake experiment without any purification.

Example 10. 1 g of OCB (obtained from Example 4) was placed in a ceramic boat in a horizontal cylindrical furnace with an inner diameter of 35 mm and then heated at a rate of 60° C. min⁻¹ up to 800° C. under argon. Heating was kept for 1 h, then, the furnace was cooled down to room temperature under argon. The resulting black powder was collected from the boat and used directly for CO₂ uptake experiment without any purification.

Example 11. 1 g of OCB (obtained from Example 5) was placed in a ceramic boat in a horizontal cylindrical furnace with an inner diameter of 35 mm and then heated at a rate of 60° C. min⁻¹ up to 800° C. under argon. Heating was kept for 1 h, then, the furnace was cooled down to room temperature under argon. The resulting black powder was collected from the boat and used directly for CO₂ uptake experiment without any purification.

Example 12. 1 g of OCB (obtained from Example 6) was placed in a ceramic boat in a horizontal cylindrical furnace with an inner diameter of 35 mm and then heated at a rate of 60° C. min⁻¹ up to 800° C. under argon. Heating was kept for 1 h, then, the furnace was cooled down to room temperature under argon. The resulting black powder was collected from the boat and used directly for CO₂ uptake experiment without any purification.

Example 13. 5 g of CB (Pearl 2000) was placed in a round bottom flask containing 100 mL HNO₃ and stirred at 90° C. for 120 h. The mixture was cooled down and centrifuged (5000 rpm, 20 min) to separate supernatant from sediment. The HNO₃ was removed from supernatant and the resulting brown powder was further dried at 80° C. overnight to give carbon nanoribbons (OCB small fragments, 3.3 g) and used for the pyrolysis.

Example 14. 5 g of CB (Pearl 2000) was placed in a round bottom flask containing 100 mL HNO₃ and stirred at 90° C. for 120 h. The mixture was cooled down and centrifuged (5000 rpm, 20 min) to separate supernatant from sediment. The sediment was centrifuged from H₂O (5000 rpm, 20 min) twice to remove yellowish transparent solution. The third centrifugation resulted in a black sediment (OCB-A, 1.3 g) and black supernatant containing OCB-B (0.9 g). H₂O was removed from the mixture of OCB-B and both OCB-A and OCB-B were further dried separately at 80° C. overnight and used for pyrolysis.

Example 15. 1 g of OCB-A was placed in a ceramic boat in a horizontal cylindrical furnace with an inner diameter of 35 mm and then heated at a rate of 60° C. min⁻¹ up to 800° C. under argon. Heating was kept for 1 h, then, the furnace was cooled down to room temperature under argon. The resulting black powder was collected from the boat and labelled PC-A used directly for CO₂ uptake experiment.

Example 16. 1 g of OCB-B was placed in a ceramic boat in a horizontal cylindrical furnace with an inner diameter of 35 mm and then heated at a rate of 60° C. min⁻¹ up to 800° C. under argon. Heating was kept for 1 h, then, the furnace was cooled down to room temperature under argon. The resulting black powder was collected from the boat and labelled PC-B used directly for CO₂ uptake experiment.

Example 17. 1 g of nanoribbons was placed in a ceramic boat in a horizontal cylindrical furnace with an inner diameter of 35 mm and then heated at a rate of 60° C. min⁻¹ up to 800° C. under argon. Heating was kept for 1 h, then, the furnace was cooled down to room temperature under argon. The resulting black powder was collected from the boat and labelled PC-C used directly for CO₂ uptake experiment.

Example 18. 1 g of nanoribbons was placed in a ceramic boat in a horizontal cylindrical furnace with an inner diameter of 35 mm and then heated at a rate of 3° C. min⁻¹ up to 800° C. under argon. Heating was kept for 1 h, then, the furnace was cooled down to room temperature under argon. The resulting black powder was collected from the boat and labelled PC-C′ used directly for CO₂ uptake experiment.

Example 19. 1 g of nanoribbons was mixed with 1 g of urea and placed in a ceramic boat in a horizontal cylindrical furnace with an inner diameter of 35 mm and then heated at a rate of 60° C. min⁻¹ up to 800° C. under argon. Heating was kept for 1 h, then, the furnace was cooled down to room temperature under argon. The resulting black powder was collected from the boat and labelled PC-C′ used directly for CO₂ uptake experiment.

While the forgoing is directed to embodiments of the present disclosure, other and further embodiments of the disclosure may be devised without departing from the basic scope thereof, and the scope thereof is determined by the claims that follow.

What is claimed is:

1. A method of forming the microporous carbon material comprising:
a. heating a carbon black in a solution of an oxidizing acid;
b. evaporation of volatiles to give an oxidized carbon black solid;
c. heating the oxidized carbon black solid under an inert atmosphere at a temperature of between about 700° C. and 900° C.

2. The method as claimed in claim 1, wherein the carbon black is chosen from commercial materials including, acetylene black, Pearl 2000, Monarch 1000, Vulcan R-X72 or Vulcan 3.

3. The method as claimed in claim 1, wherein the oxidizing acid is nitric acid.

4. The method as claimed in claim 3, wherein the carbon black/nitric acid mixture is heated at about 90° C. for between about 24 hours and about 120 hours.

5. The method as claimed in claim 1, wherein the oxidized carbon black is heated at about 800° C. for about 1 hour.

6. A method of forming the microporous carbon material comprising:
a. heating a carbon black in a solution of an oxidizing acid;
b. separating the oxidized carbon black solid from the supernatant liquid;
c. heating the oxidized carbon black solid under an inert atmosphere at a temperature of between about 700° C. and 900° C.

7. The method as claimed in claim 6, wherein the carbon black is chosen from commercial materials including, acetylene black, Pearl 2000, Monarch 1000, Vulcan R-X72 or Vulcan 3.

8. The method as claimed in claim 6, wherein the oxidizing acid is nitric acid.

9. The method as claimed in claim 8, wherein the carbon black/nitric acid mixture is heated at about 90° C. for between about 24 hours and about 120 hours.

10. The method as claimed in claim 6, wherein the oxidized carbon black is separated from the acid solution by centrifugation.

11. The method as claimed in claim 10, wherein the centrifugation is carried out at about 5000 rpm for about 20 min.

12. The method as claimed in claim 6, wherein the oxidized carbon black is heated at about 800° C. for about 1 hour.

13. A material for CO₂ adsorption comprising: a microporous carbon material formed according to the preceding claims, with a surface area of at least 300 m²/g, and a total pore volume of at least 0.11 cm³/g, wherein 100% of pores of the porous material have diameters of less than 8 Å as measured using the density functional theory (DFT) method, wherein the porous material has an oxygen content of between about 6 wt % and 22 wt % as measured by X-ray photoelectron spectroscopy, and wherein the porous material has a CO₂ adsorption capacity at 1 bar of more than about 2 mmol/g at 25° C.

14. The material of claim 6, wherein more than 80% of pores of the porous material have diameters of less than 5 Å as measured using the DFT method.

15. The material of claim 6, wherein the porous material has a CO₂ adsorption capacity at 1 bar of more than about 2 mmol/g at 25° C.

16. The material of claim 2, wherein the porous material has an oxygen content of between about 11 wt % and 22 wt % as measured by X-ray photoelectron spectroscopy.
